(19) United States
(12) Patent Application Publication
(10) Pub. No.: US 2026/0204625 A1
(43) Pub. Date: Jul. 16, 2026

(54) NIOBIUM-CONTAINING AGYRODITE-TYPE SOLID ELECTROLYTE COMPOSITION

(71) Applicant: GM Global Technology Operations LLC, Detroit, MI (US)

(72) Inventors: Qili Su, Shanghai (CN); Zhe Li, Shanghai (CN); Haijing Liu, Shanghai (CN); Thomas A. Yersak, Royal Oak, MI (US); Guowei Zhao, Huanggang (CN)

(21) Appl. No.: 19/042,232

(22) Filed: Jan. 31, 2025

(30) Foreign Application Priority Data
Jan. 15, 2025 (CN) 202510069208.7

(51) Int. Cl. H01M 10/0562; H01M 50/431; H01M 50/443

(52) U.S. Cl. CPC H01M 10/0562; H01M 50/431; H01M 50/443; H01M 2300/008

(57) ABSTRACT

Niobium-containing argyrodite-type solid electrolyte compositions having enhanced air stability and enhanced dendrite suppression capabilities are described. The niobium-containing argyrodite-type solid electrolyte compositions include co-substituted argyrodite-type solid electrolyte particles having an argyrodite-type crystal structure and the general formula Li_{5.5}(P₁₋ᵢNbᵢ)(S_{4.5-j}Oⱼ)X_{1.5}, where: X is at least one halogen; i is in the range from 0.01 to 0.12; and j is in the range from 0.01 to 0.6. The co-substituted argyrodite-type solid electrolyte particles may be used in an electrochemical cell, such as an all- or semi-solid-state lithium-ion battery. In some aspects, the co-substituted particles are formed from niobium oxide, lithium sulfide, phosphorous pentasulfide, and a lithium halide. Additionally, or alternatively, the co-substituted particles are formed via ball milling.

### INTRODUCTION

The disclosure relates to the field of niobium-containing argyrodite-type solid electrolyte compositions and, more specifically, to systems, methods, and compositions for optimizing performance of solid-state batteries.

High energy-density electrochemical cells, such as lithium-ion batteries, can be used in a variety of consumer products and vehicles. These include Hybrid Electric Vehicles (HEVs) and Electric Vehicles (EVs).

Solid electrolytes used in all-solid-state batteries (“ASSBs”) and semi-solid-state batteries (“SSSBs”) may be used to provide benefits over liquid electrolytes. One class of solid electrolytes, argyrodite-type solid electrolytes, may offer optimized ionic conductivity and deformability. But, argyrodite-type solid electrolytes exhibit poor air stability and are prone to lithium dendrite growth.

The poor air stability of argyrodite-type solid electrolytes requires extremely low-humidity environments to maintain the benefits of the argyrodite-type solid electrolytes and avoid generating hydrogen sulfide gas. Further, the lithium dendrite growth occurs because formation of the solid electrolyte interphase creates products that are related to the formation of lithium dendrites, which result in short circuiting of the cell.

Therefore, there is a need in the art for argyrodite-type solid electrolytes with enhanced air stability and enhanced dendrite suppression capabilities.

### SUMMARY

Systems, methods, and devices in accordance with the present disclosure provide argyrodite-type solid electrolyte particles having niobium and oxygen co-substitution of halogen-rich argyrodite-type solid electrolytes.

Beneficially, the niobium and oxygen co-substitution enhances the air stability of the resulting argyrodite-type solid electrolyte. While not being bound by theory, it is believed that substituting the soft acid of niobium for the hard acid of phosphorous and the hard base of oxygen for the soft base of sulfur enhances air stability of the argyrodite-type solid electrolyte by enhancing the overall bond strength of the crystal lattice. More specifically, niobium exhibits a stronger bond with sulfide than does phosphorous and oxygen exhibits a stronger bond with phosphorous than does niobium.

Further, niobium and oxygen co-substitution suppresses dendrite growth by enhancing reductive stability of the electrolyte. While not being bound by theory, it is believed that the co-substitution results in formation of lithium oxide and elemental niobium at the interface between the anode electroactive material, which inhibits growth of lithium dendrites and enhances uniformity of lithium deposition.

Moreover, the co-substituted argyrodite-type solid electrolyte may have an increased chlorine content to enhance ionic conductivity by introducing more lithium-ion vacancies.

According to aspects of the present disclosure, a method of forming co-substituted argyrodite-type solid electrolyte particles includes combining starting materials, milling the starting materials in an inert environment to produce co-substituted argyrodite-type solid electrolyte particles, sealing the co-substituted argyrodite-type solid electrolyte particles in a container, and annealing the co-substituted argyrodite-type solid electrolyte particles in the container. The starting materials include niobium oxide, lithium sulfide, phosphorous pentasulfide, and a lithium halide. The starting materials are combined in an amount having a stoichiometric abundance given by the general formula Li_{5.5}(P₁₋ᵢNbᵢ)(S_{4.5-j}Oⱼ)X_{1.5}, where: X is at least one halogen; i is in the range from 0.01 to 0.12; and j is in the range from 0.01 to 0.6. The co-substituted argyrodite-type solid electrolyte particles, after milling, have an argyrodite-type crystal structure and the general formula the general formula Li_{5.5}(P₁₋ᵢNbᵢ)(S_{4.5-j}Oⱼ)X_{1.5}.

According to further aspects of the present disclosure, the niobium oxide is selected from the group consisting of Nb₂O₅, Nb₂O₃, NbO₂, NbO, and combinations thereof.

According to further aspects of the present disclosure, i is 0.10.

According to further aspects of the present disclosure, j is 2.5 times i.

According to further aspects of the present disclosure, the phosphorus is partially substituted by at least one element selected from the group consisting essentially of vanadium, arsenic, antimony, and tin.

According to further aspects of the present disclosure, the at least one halogen is selected from the group consisting of chlorine, bromine, and iodine.

According to further aspects of the present disclosure, the at least one halogen is chlorine and at least one of bromine and iodine.

According to further aspects of the present disclosure, the at least one halogen is chlorine.

According to further aspects of the present disclosure, the co-substituted argyrodite-type solid electrolyte particles have a particle size from 50 nm to 50 μm.

According to further aspects of the present disclosure, the co-substituted argyrodite-type solid electrolyte particles have an ionic conductivity from 1 mS/cm to 10 mS/cm.

According to further aspects of the present disclosure, the co-substituted argyrodite-type solid electrolyte particles, after exposure to a humidity from 40% to 45% for 1 hour, have an ionic conductivity from 0.1 mS/cm to 5 mS/cm.

According to further aspects of the present disclosure, the milling the starting materials includes sealing the materials in zirconium oxide containers and ball milling at a rate from 200 rpm to 800 rpm for a period from 4 hours to 24 hours.

According to further aspects of the present disclosure, the annealing the co-substituted argyrodite-type solid electrolyte particles in the container is at a temperature from 300° C. to 600° C. and for a period from 6 hours to 24 hours.

According to aspects of the present disclosure, a solid-state electrolyte includes co-substituted argyrodite-type solid electrolyte particles having an argyrodite-type crystal structure and the general formula Li_{5.5}(P₁₋ᵢNbᵢ)(S_{4.5-j}Oⱼ)X_{1.5}, where: X is at least one halogen; i is in the range from 0.01 to 0.12; and j is in the range from 0.01 to 0.6.

According to further aspects of the present disclosure, j is 2.5 times i.

According to further aspects of the present disclosure, i is 0.10.

According to further aspects of the present disclosure, j is 0.25.

According to aspects of the present disclosure, an electrochemical cell includes

an anode, an electrolyte, a cathode, and co-substituted argyrodite-type solid electrolyte particles. The co-substituted argyrodite-type solid electrolyte particles have an argyrodite-type crystal structure and the general formula Li_{5.5}(P₁₋ᵢNbᵢ)(S_{4.5-j}Oⱼ)X_{1.5}, where: X is at least one halogen; i is in the range from 0.01 to 0.12; and j is in the range from 0.01 to 0.6.

According to further aspects of the present disclosure, the co-substituted argyrodite-type solid electrolyte particles are present in at least one of the anode, the electrolyte, and the cathode.

According to further aspects of the present disclosure, the electrolyte is a liquid electrolyte, and wherein the co-substituted argyrodite-type solid electrolyte particles form a separator.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

The drawings are illustrative and not intended to limit the subject matter defined by the claims. Exemplary aspects are discussed in the following detailed description and shown in the accompanying drawings in which:

FIG. 1 illustrates a schematic solid-state battery including a co-substituted argyrodite-type solid electrolyte material, according to aspects of the present disclosure;

FIG. 2 illustrates a schematic liquid-electrolyte battery having a separator including the co-substituted argyrodite-type solid electrolyte material, according to aspects of the present disclosure;

FIG. 3 illustrates a method of forming the co-substituted argyrodite-type solid electrolyte particles, according to aspects of the present disclosure;

FIG. 4 illustrates x-ray diffraction spectra for a reference argyrodite-type solid electrolyte and example samples of co-substituted argyrodite-type solid electrolyte materials prepared according to aspects of the present disclosure; and

FIG. 5 illustrates a chart of moisture stability for the reference argyrodite-type solid electrolyte and example samples of co-substituted argyrodite-type solid electrolyte materials prepared according to aspects of the present disclosure.

### DETAILED DESCRIPTION

The following detailed description is merely exemplary in nature and is not intended to limit the application and uses. Furthermore, there is no intention to be bound by expressed or implied theory presented in the preceding introduction, summary, or brief description of the drawings or the following detailed description.

Solid-state electrolytes as disclosed herein include co-substituted argyrodite-type solid electrolyte particles having an argyrodite-type crystal structure and the general formula Li_{5.5}(P₁₋ᵢNbᵢ)(S_{4.5-j}Oⱼ)X_{1.5}, where X is at least one halogen, i is in the range from 0.01 to 0.12, and j is in the range from 0.01 to 0.6. In some aspects, j is 2.5 times i.

As can be seen, niobium and oxygen are co-substituted for phosphorous and sulfur in an argyrodite-type solid electrolyte, such as Li_{5.5}PS_{4.5}Cl_{1.5}, to form the co-substituted argyrodite-type solid electrolyte. In some aspects, the phosphorus may be further partially substituted by at least one element selected from the group consisting essentially of vanadium, arsenic, antimony, and tin.

In some aspects, the halogen is selected from the group consisting of chlorine, bromine, and iodine. In some aspects, the at least one halogen is chlorine and at least one of bromine and iodine.

In some aspects, the halogen is chlorine. Beneficially, the introduction of chlorine can decrease energy barriers for lithium-ion migration in both short and long diffusion length scales and introduce more lithium-ion vacancies to enhance the ionic conductivity as compared to, for example, Li₆PS₅Cl.

In some aspects, the co-substituted argyrodite-type solid electrolyte particles have an ionic conductivity from 1 mS/cm to 10 mS/cm. More preferably, the co-substituted argyrodite-type solid electrolyte particles have an ionic conductivity of 3.1 mS/cm. As used herein, the ionic conductivity measurements are at 25° C.

Beneficially, the co-substituted argyrodite-type solid electrolyte particles are stable in the presence of moister and maintain an optimized ionic conductivity after exposure to humidity. In some aspects, the co-substituted argyrodite-type solid electrolyte particles, after exposure to a humidity from 40% to 45% for 1 hour, have an ionic conductivity from 0.1 mS/cm to 5 mS/cm. More preferably, the co-substituted argyrodite-type solid electrolyte particles, after exposure to a humidity from 40% to 45% for 1 hour, have an ionic conductivity 1.6 mS/cm.

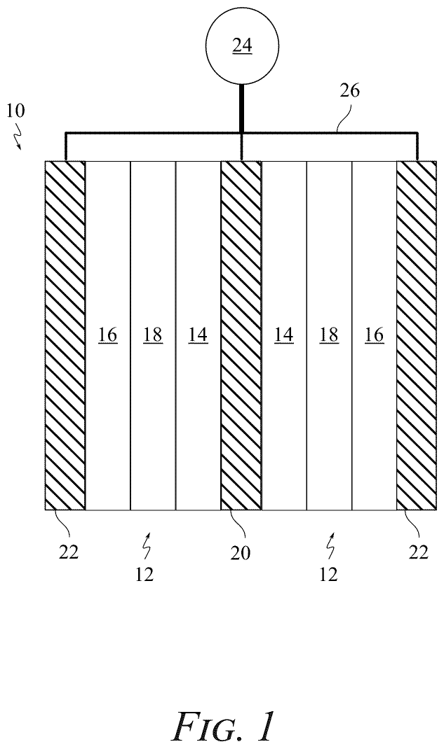

FIG. 1 illustrates a schematic solid-state battery 10, according to aspects of the present disclosure. The solid-state battery 10 may be an all-solid-state battery or a semi-solid-state battery.

The solid-state battery 10 has a tri-layer structure having two solid-state battery cells 12. Each solid-state battery cell 12 includes a pair of electrodes (anode 14 and cathode 16) separated by a solid-state electrolyte layer 18. The anodes 14 are disposed on an anodic current collector 20 and each cathode 16 is disposed on a cathodic current collector 22, with each respective current collector being disposed opposite the solid-state electrolyte layer 18.

The anode 14 is configured to, via the anode electroactive material, intercalate ions while the solid-state battery cell 12 is charging and de-intercalate ions while the solid-state battery cell 12 is discharging. The anode electroactive material may be, for example, a lithiated material, a silicon material, a silicon oxide material, a silicon/carbon composite material, a silicon/metal alloy material, a graphite material, a tin oxide material, combinations thereof, and the like.

The anode 14 may be loaded to optimize operating characteristics of the solid-state battery cell 12. In some aspects, the anode electroactive material is at least 50 wt % of the anode 14. In some preferred aspects, the anode electroactive material is from 70 wt % to 90 wt % of the anode 14. In some further preferred aspects, the anode electroactive material is at least 99 wt % of the anode 14.

The anode 14 may include a carbon material to enhance characteristics of the anode 14 and performance of the solid-state battery cell 12. For example, the carbon material may be selected to optimize electrical conductivity of the anode 14, promote a particular morphology of the anode electroactive material, enhance ion intercalation and deintercalation, optimize mechanical properties of the anode 14, combinations thereof, and the like. The carbon material may be selected from the group consisting of graphite, carbon nanotubes, hard carbon, or soft carbon.

Additionally, or alternatively, the anode 14 may include the argyrodite-type particles to enhance characteristics of the anode 14 and performance of the solid-state battery cell 12.

The cathode 16 is configured to, via the cathode electroactive material, intercalate the ions received from the anode 14 when the solid-state battery cell 12 is discharging and de-intercalate the ions for transport to the anode 14 while the solid-state battery cell 12 is charging. The cathode electroactive material is cooperative with the anode electroactive material to facilitate ion flow and electron flow between the anode 14 and the cathode 16. The cathode active material may be, for example, a transition-metal electroactive material, such as a transition-metal-rich electroactive material. In some aspects, the cathode electroactive material is selected from the group consisting of a lithium- and manganese-rich (“LMR”) material, a nickel manganese cobalt (“NCM” or “NMC”) material, a lithium nickel cobalt aluminum (“NCA”) material, a lithium nickel cobalt manganese aluminum (“NCMA”) material, a lithium iron phosphate (“LFP”) material, a lithium manganese iron phosphate (“LMFP”) material, a lithium nickel oxide (“LNO”) material, and combinations thereof.

The cathode 16 may be loaded to optimize operating characteristics of the solid-state battery cell 12. In some aspects, the cathode electroactive material is at least 50 wt % of the cathode 16. In some preferred aspects, the cathode electroactive material is from 70 wt % to 90 wt % of the cathode 16.

The cathode 16 may include one or more additives to enhance characteristics of the cathode 16 and performance of the solid-state battery cell 12. The one or more additives may enhance electronic properties of the cathode 16, promote a particular morphology of the cathode electroactive material, enhance ion intercalation and deintercalation, optimize mechanical properties of the cathode 16, combinations thereof, and the like. For example, the cathode additives may include a pre-lithiation agent to increase the initial coulombic efficiency of the solid-state battery cell 12. Additionally, or alternatively, the cathode additives may include compounds to promote formation of a stable solid-state electrolyte interphase and/or cathode electrolyte interphase.

Additionally, or alternatively, the cathode 16 may include the argyrodite-type particles to enhance characteristics of the cathode 16 and performance of the solid-state battery cell 12.

The solid-state electrolyte layer 18 is configured to electronically isolate the anode 14 and the cathode 16 and provide for ionic conduction therethrough. The solid-state electrolyte layer 18 may be formed from or may include the argyrodite-type particles. The solid-state electrolyte layer 18 may be an all-solid-state electrolyte layer or a semi-solid-state electrolyte layer.

The all-solid-state electrolyte layer consists of solid-state electrolyte particles. The solid-state electrolyte particles may be or may include the argyrodite-type particles. The semi-solid-state electrolyte layer includes a solid-state-electrolyte component and a liquid-electrolyte component. The solid-state electrolyte particles may be or may include the argyrodite-type particles.

The liquid-electrolyte component may be a non-flammable liquid electrolyte. The liquid-electrolyte component may be present in an amount less than about 15 wt % of the mass of the semi-solid-state electrolyte. In some aspects, the liquid-electrolyte component is present in an amount between about 1 wt % and about 15 wt % of the mass of the semi-solid-state electrolyte. Beneficially, the solid-state electrolyte particles may be provided in an amount cooperative with the non-flammable liquid electrolyte to thereby increase the ionic conductivity of the electrolyte above a predetermined threshold. Additionally, or alternatively, the solid-state electrolyte particles may be provided in an amount cooperate with the non-flammable liquid electrolyte to thereby slow the charge transfer kinetics of the electrolyte below a predetermined threshold.

The anodic current collector 20 is configured to collect free electrons from and distribute them to the adjacent anode 14, and the cathodic current collector 22 is configured to collect free electrons from and distribute them to the adjacent cathode 16. The free electrons are moved between the anodic current collector 20 and the cathodic current collectors 22 through an external device 24 via an external circuit 26. The external device 24 may be a load that consumes electric power from the solid-state battery cell 12 and/or a power source that provides electric power to the solid-state battery cell 12.

While the above description has been made with reference solid-state batteries, the co-substituted argyrodite-type solid electrolyte particles may be employed in liquid-electrolyte batteries. In addition to being included in the anode 14 and/or cathode 16 as described above, the co-substituted argyrodite-type solid electrolyte particles may be formed into a separator or used as a component thereof.

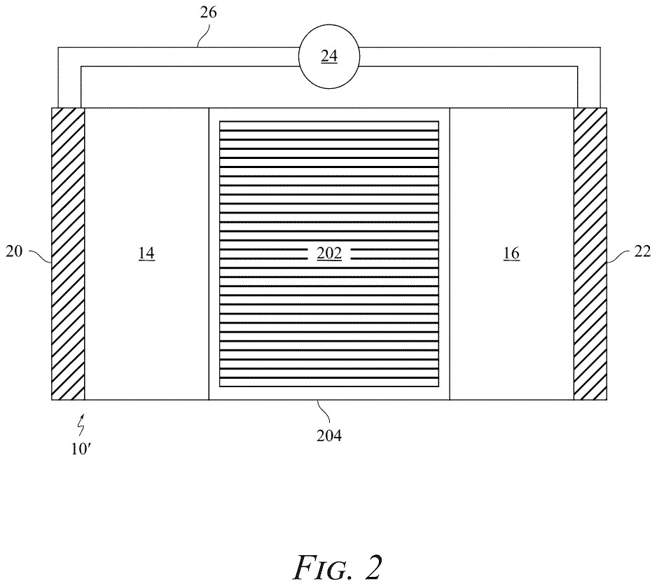

Referring now to FIG. 2, a schematic liquid-electrolyte battery 10′ is shown according to aspects of the present disclosure. The liquid-electrolyte battery 10′ includes a liquid electrolyte 202 and a separator 204 between a respective pair of electrodes (anode 14 and cathode 16). The anode 14 is disposed on the anodic current collector 20 and the cathode 16 is disposed on the cathodic current collector 22. Each respective current collector being disposed on the side of its electrode that is opposite to the separator 204.

The liquid electrolyte 202 is formed from an electrolyte solution and promotes movement of ions between the anode 14 and the cathode 16 during charging and discharging of the liquid-electrolyte battery 10′.

The separator 204 is configured to electronically isolate the anode 14 and the cathode 16 and to allow ionic conduction therethrough. The separator 204 is formed from or includes the argyrodite-type particles.

The anodic current collector 20 and the cathodic current collector 22 are configured to collect and distribute free electrons from and to the adjacent anode 14 and cathode 16. The free electrons are moved between the anodic current collector 20 and the cathodic current collector 22 via an external device 26. The external device 26 may include an external device 24 which may be a load that consumes electric power from the liquid-electrolyte battery 10′ and/or a power source that provides electric power to the liquid-electrolyte battery 10′.

Each of the anode 14, the cathode 16, and the separator 204 may further include the liquid electrolyte 202. For example, pores of the anode 14, the cathode 16, and/or the separator 204 may be infilled with the liquid electrolyte 202.

The anodic current collector 20 and the cathodic current collector 22 are configured to collect and distribute free electrons from and to the adjacent anode 14 and cathode 16. The free electrons are moved between the anodic current collector 20 and the cathodic current collector 22 via an external device 26. The external device 26 may include an external device 24 which may be a load that consumes electric power from the liquid-electrolyte battery 10′ and/or a power source that provides electric power to the liquid-electrolyte battery 10′.

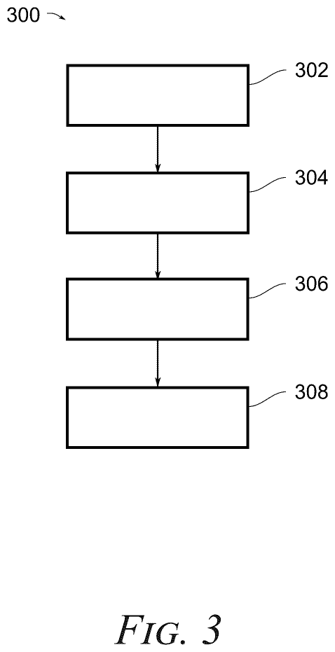

FIG. 3 illustrates a method 300 of forming co-substituted argyrodite-type solid electrolyte particles. At block 302, starting materials are combined. The starting materials include powders of a plurality of compounds that will be combined to form the co-substituted argyrodite-type solid electrolyte particles. In some aspects, the starting materials include niobium oxide, lithium sulfide, phosphorous pentasulfide, and a lithium halide. In some aspects, the niobium oxide is selected from the group consisting of Nb₂O₅, Nb₂O₃, NbO₂, NbO, and combinations thereof. The starting materials are selected in an amount that provides a stoichiometric abundance of the desired co-substituted argyrodite-type solid electrolyte particles given by the general formula Li_{5.5}(P₁₋ᵢNbᵢ)(S_{4.5-j}Oⱼ)X_{1.5} where X is at least one halogen, i is in the range from 0.01 to 0.12, and j is in the range from 0.01 to 0.6.

At block 304, the starting materials are milled, for example using ball milling, in an inert environment to produce the desired co-substituted argyrodite-type solid electrolyte particles. In some aspects, the starting materials are sealed in zirconium oxide containers having the inert environment for the ball milling process. In some aspects, the ball milling is conducted at a rate from 200 rpm to 800 rpm. More preferably, the ball milling is conducted at a rate of 600 rpm.

In some aspects, the ball milling is conducted for a period of time from 4 hours to 24 hours. More preferably, the ball milling is conducted for 16 hours. The grinding media of the ball mill may be selected to provide a desired particle-size distribution of the co-substituted argyrodite-type solid electrolyte particles. In some aspects, the co-substituted argyrodite-type solid electrolyte particles have a particle size from 50 nm to 50 μm. More preferably, the particle size of the co-substituted argyrodite-type solid electrolyte particles is 5 μm. As used herein, particle sizes are measured based on a D50 distribution.

At block 306, the co-substituted argyrodite-type solid electrolyte particles are sealed in a container. The container is selected to withstand the annealing conditions. In some aspects, the container is a quartz tube.

At block 308, the co-substituted argyrodite-type solid electrolyte particles are annealed in the container. In some aspects, the annealing is conducted at a temperature in the range from 300° C. to 600° C. More preferably, the annealing is conducted at a temperature of 550° C. The co-substituted argyrodite-type solid electrolyte particles are annealed for a period of time from 6 hours and 24 hours. More preferably, the co-substituted argyrodite-type solid electrolyte particles are annealed for a period of 10 hours.

### EXAMPLES

Samples of argyrodite-type solid electrolyte particles are prepared. The starting materials of niobium pentoxide (Nb₂O₅), lithium sulfide (Li₂S), phosphorous pentasulfide (P₂S₅), and lithium chloride (LiCl) powders are selected in amounts to produce co-substituted argyrodite-type solid electrolyte particles having the general formula Li_{5.5}(P₁₋ᵢNbᵢ)(S_{4.5-2.5i}O_{2.5i})Cl_{1.5}.

The starting materials for each respective sample are sealed in a zirconium oxide jar with an atmosphere of argon. Ball milling is conducted at 400 rpm for 16 hours. After milling, the mixtures for each respective sample are sealed in quartz tubes and annealed at 550° C. for 10 hours.

Specifically, five samples are prepared, each with a respective value of i between 0 and 0.20. The first sample is prepared for i=0.00, resulting in particles having the formula Li_{5.5}P₁S_{4.5}Cl_{1.5}. The second sample is prepared for i=0.05, resulting in argyrodite-type solid electrolyte particles having the formula Li_{5.5}(P_{0.95}Nb_{0.05})(S_{4.375}O_{0.125})Cl_{1.5}. The third sample is prepared for i=0.10, resulting in argyrodite-type solid electrolyte particles having the formula Li_{5.5}(P_{0.9}Nb_{0.1})(S_{4.25}O_{0.25})Cl_{1.5}. The fourth sample is prepared for i=0.15, resulting in argyrodite-type solid electrolyte particles having the formula Li_{5.5}(P_{0.85}Nb_{0.15})(S_{4.125}O_{0.375})Cl_{1.5}. The fifth sample is prepared for i=0.20, resulting in argyrodite-type solid electrolyte particles having the formula Li_{5.5}(P_{0.8}Nb_{0.2})(S₄O_{0.5})Cl_{1.5}.

After annealing each of the five samples is subjected to x-ray diffraction analysis, ionic conductivity analysis, moisture stability analysis, and stability with a lithium-metal interface.

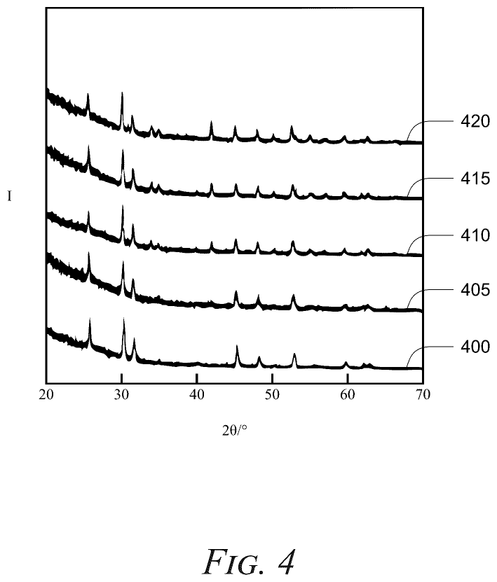

Referring now to FIG. 4, x-ray diffraction (“XRD”) spectra for each of the samples is shown. Line 400 represents the XRD spectrum for the first sample (i=0.00). Line 405 represents the XRD spectrum for the second sample (i=0.05). Line 410 represents the XRD spectrum for the third sample (i=0.10). Line 415 represents the XRD spectrum for the fourth sample (i=0.15). Line 420 represents the XRD spectrum for the fifth sample (i=0.20).

As can be seen, for each of the samples, the intensity (in a.u.) of the diffraction peaks at about 25°, 30°, and 32° can be associated with indices argyrodite crystalline phase (specifically, the (220), (311), and (222) planes, respectively). Moreover, increasing intensity of impurity peaks near 34° and 35° can be seen for samples three through five (i=0.10 and above).

The ionic conductivity of the first through the fourth samples is analyzed and reproduced in the table below

| Composition | Ionic conductivity (mS/cm @25° C.) |
|---|---|
| i = 0.00 | 8.1 |
| i = 0.05 | 4.4 |
| i = 0.10 | 3.1 |
| i = 0.15 | 1.1 |

As can be seen, ionic conductivity trends downward with increasing co-substitution. While not being bound by theory, it is believed that that this reduction is due to the co-substitution decreasing the presence of the argyrodite phase, as shown in FIG. 4.

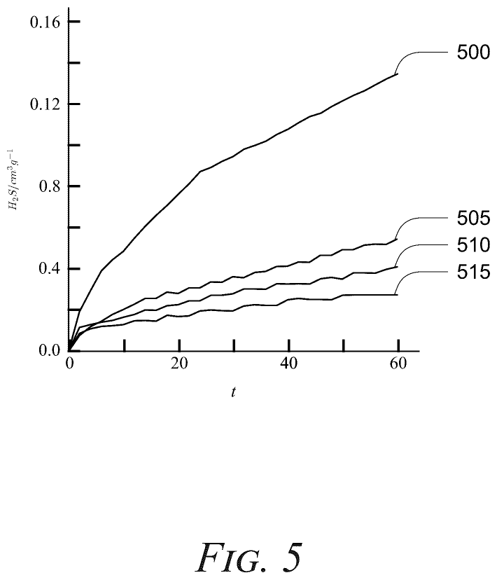

Referring now to FIG. 5, a chart of moisture stability for the first through fourth samples is shown. Data for the chart is generated by exposing each sample to atmospheric conditions with a humidity of 40%-45% and the amount of hydrogen sulfide produced is monitored over the period of an hour.

Line 500 represents the amount of hydrogen sulfide produced for the first sample (i=0.00). Line 505 represents the amount of hydrogen sulfide produced for the second sample (i=0.05). Line 510 represents the amount of hydrogen sulfide produced for the third sample (i=0.10). Line 515 represents the amount of hydrogen sulfide produced for the fourth sample (i=0.15).

As can be seen, each co-substituted sample provides a significant improvement to the moisture stability of the solid-state electrolyte particles and, as the fraction of co-substitution increases, so does the overall stability. Moreover, as the fraction of co-substitution increases, both the rate of generation and the total amount of hydrogen sulfide liberated decrease.

The stability of the co-substituted argyrodite-type solid electrolyte particles with a lithium-metal interface is analyzed by placing a solid-state electrolyte layer of the respective co-substituted argyrodite-type solid electrolyte particles between two pieces of lithium metal and voltage cycling the assembly at 0.1 mA/cm² in one-hour intervals. The first sample (i=0.00) and the third sample (i=0.10) are compared. The first sample forms lithium dendrites within the sulfide electrolyte while the co-substituted sample enhances stability for more than 700 hours of cycling without significant dendrite formation.

What is claimed is:

1. A method of comprising:
combining starting materials including niobium oxide, lithium sulfide, phosphorous pentasulfide, and a lithium halide in an amount having a stoichiometric abundance given by the general formula Li_{5.5}(P₁₋ᵢNbᵢ)(S_{4.5-j}Oⱼ)X_{1.5} where:
X is at least one halogen,
i is in a range from 0.01 to 0.12, and
j is in a range from 0.01 to 0.6;
milling the starting materials in an inert environment to produce co-substituted argyrodite-type solid electrolyte particles having an argyrodite-type crystal structure and the general formula Li_{5.5}(P₁₋ᵢNbᵢ)(S_{4.5-j}Oⱼ)X_{1.5};
sealing the co-substituted argyrodite-type solid electrolyte particles in a container; and
annealing the co-substituted argyrodite-type solid electrolyte particles in the container.

2. The method of claim 1, wherein the niobium oxide is selected from the group consisting of Nb₂O₅, Nb₂O₃, NbO₂, NbO, and combinations thereof.

3. The method of claim 1, wherein i is 0.10.

4. The method of claim 1, wherein j is 2.5 times i.

5. The method of claim 1, wherein the phosphorus is partially substituted by at least one element selected from the group consisting essentially of vanadium, arsenic, antimony, and tin.

6. The method of claim 1, wherein the at least one halogen is selected from the group consisting of chlorine, bromine, and iodine.

7. The method of claim 1, wherein the at least one halogen is chlorine and at least one of bromine and iodine.

8. The method of claim 1, wherein the at least one halogen is chlorine.

9. The method of claim 1, wherein the co-substituted argyrodite-type solid electrolyte particles have a particle size from 50 nm to 50 μm.

10. The method of claim 1, wherein the co-substituted argyrodite-type solid electrolyte particles have an ionic conductivity from 1 mS/cm to 10 mS/cm.

11. The method of claim 1, wherein the co-substituted argyrodite-type solid electrolyte particles, after exposure to a humidity from 40% to 45% for 1 hour, have an ionic conductivity from 0.1 mS/cm to 5 mS/cm.

12. The method of claim 1, wherein the milling the starting materials includes sealing the materials in zirconium oxide containers and ball milling at a rate from 200 rpm to 800 rpm for a period from 4 hours to 24 hours.

13. The method of claim 1, wherein the annealing the co-substituted argyrodite-type solid electrolyte particles in the container is at a temperature from 300° C. to 600° C. and for a period from 6 hours to 24 hours.

14. A solid-state electrolyte comprising:
co-substituted argyrodite-type solid electrolyte particles having an argyrodite-type crystal structure and the general formula Li_{5.5}(P₁₋ᵢNbᵢ)(S_{4.5-j}Oⱼ)X_{1.5}, where:
X is at least one halogen,
i is in the range from 0.01 to 0.12, and
j is in the range from 0.01 to 0.6.

15. The solid-state electrolyte of claim 14, wherein j is 2.5 times i.

16. The solid-state electrolyte of claim 14, wherein i is 0.10.

17. The solid-state electrolyte of claim 14, wherein j is 0.25.

18. An electrochemical cell comprising:
an anode;
an electrolyte;
a cathode; and
co-substituted argyrodite-type solid electrolyte particles having an argyrodite-type crystal structure and the general formula Li_{5.5}(P₁₋ᵢNbᵢ)(S_{4.5-j}Oⱼ)X_{1.5}, where:
X is at least one halogen,
i is in the range from 0.01 to 0.12, and
j is in the range from 0.01 to 0.6.

19. The electrochemical cell of claim 18, wherein the co-substituted argyrodite-type solid electrolyte particles are present in at least one of the anode, the electrolyte, and the cathode.

20. The electrochemical cell of claim 18, wherein the electrolyte is a liquid electrolyte, and wherein the co-substituted argyrodite-type solid electrolyte particles form a separator.
